(19) United States
(12) Patent Application Publication
(10) Pub. No.: US 2013/0094967 A1
(43) Pub. Date: Apr. 18, 2013

(54) VERTICAL AXIS WIND TURBINE SYSTEM

(71) Applicant: MAX SU, TAINAN CITY (TW)

(72) Inventor: MAX SU, TAINAN CITY (TW)

(21) Appl. No.: 13/273,310

(22) Filed: Oct. 14, 2011

(51) Int. Cl. F03D 3/02

(52) U.S. Cl. 416/202

(57) ABSTRACT

A vertical axis wind turbine system is revealed. Two vertical axis wind supply units are arranged beside a support rod and between an upper and a lower connection plates. The vertical axis wind supply unit includes blades around a rotor shaft. Each blade includes a blade body and valves. The blade body is a helical plate having a plurality of crossed barriers and insertion holes among barriers. Moreover, the valves are fixed on an upwind surface of the blade body and an upper side of the valve is connected to the blade body. Each valve is corresponding to at least one insertion hole. Each of the two rotor shafts are connected to a generator set by a transmission set. When wind turns the blades, each blade spin the rotor shaft and the transmission set transfers energy generated by the rotating blades to the generator set for conversion to electrical power.

### BACKGROUND OF THE INVENTION

1. Field of the Invention

The present invention relates to a vertical axis wind turbine system, especially to a vertical axis wind turbine system having one-way force-taken blades in which wind power is applied to an upwind surface completely and resistance over a downwind surface caused by wind is reduced. Thus the vertical axis wind turbine system provides good operating efficiency to generator sets and the efficiency of power generation is increased.

2. Description of Related Art

Generally, vertical axis wind turbines are used to convert kinetic energy from air to mechanical energy and transmit the mechanical energy to generator sets for electricity production. A plurality of helical blades is connected to a rotor. By the design of the blades, wind acts on the blades to drive the rotor and the rotor is connected to generator sets. Thus the kinetic energy of the air is converted to electricity. However, helical blades of the conventional vertical axis wind turbines include upwind surfaces and downwind surfaces. The resistance over the whole downwind surface caused by wind is quite large and this is opposite to the pushing force over the whole upwind surface caused by wind. The opposing forces partially cancel each other. Thus the power generation efficiency is reduced.

### SUMMARY OF THE INVENTION

Therefore it is a primary object of the present invention to provide a vertical axis wind turbine system in which the design of blades of vertical axis wind supply units is similar to the design of one-way valves, allowing wind force applied to an upwind surface completely. Moreover, resistance over a downwind surface caused by wind is reduced. Thus the blade receives force only in a single direction. Furthermore, the cross section of barriers that form a blade body is wing shaped so that operating efficiency of the vertical axis wind supply unit is further improved. Therefore the efficiency of power generation is increased significantly.

In order to achieve the above object, the vertical axis wind turbine system according to the present invention includes an upper connection plate, a lower connection plate, a support rod, two vertical axis wind supply units receiving force in one direction, two transmission sets and a generator set. The support rod is set between centers of the upper connection plate and the lower connection plate while the two one-way force-taken vertical axis wind supply units are respectively arranged between sides of the upper connection plate and the lower connection plate. The vertical axis wind supply unit receives forces only in one direction and includes three blades arranged equally around a rotor shaft. Each blade consists of a blade body and valves. The blades body is a curved and helical plate having a plurality of horizontal and perpendicular barriers. A plurality of insertion holes is formed among the crossed barriers and the cross section of each barrier is wing-shaped. An upwind surface of the blade body is fixed with the valves and only the upper side of each valve is connected to the blade body. Each valve is corresponding to at least one insertion hole. Each rotor shaft is connected to the generator set by the transmission set.

When wind blows, the upwind surface of the blade of the vertical axis wind supply unit is applied with a force. The valves are attached to the insertion holes closely so as to make the wind act on the upwind surface completely. When a force of wind is applied to the downwind surface of the blade, the wind passes through the insertion holes of the blade body to blow the valves open so that the valves are separated from the insertion holes. Thus the resistance over the downwind surface of the blade body caused by the wind is reduced. Moreover, the design of the one-way force-taken vertical axis wind supply unit and the wing-shaped cross section of each barrier further decrease the wind resistance (drag) and improve the working efficiency of the vertical axis wind supply unit. After mechanical energy converted from kinetic energy of the wind being transmitted from the vertical axis wind supply unit to the generator set by the transmission set, the power generation efficiency of the generator set is increase significantly.

The valves are fixed on the blade body by cables. The cable passes through the upper side of each valve and then two ends of the cable are fixed on the blade body so as to fasten the valves firmly on the blade body.

The transmission set is composed of a drive wheel fixed on the rotor shaft of the vertical axis wind supply unit, a driven wheel fixed on an operating shaft of the generator set, and a drive belt around the drive wheel and the driven wheel.

The upper connection plate is connected to one end of each of a plurality of fixing ropes while the other end of each fixing rope is fixed on buildings or on the ground. Thus the vertical axis wind turbine system of the present invention is installed on the buildings or on the ground

Along the rotor shaft of the one-way vertical axis wind supply unit, a plurality sets of modularized one-way vertical axis wind supply units can be connected in series on top of the upper connection plate. Thus rotary power of the rotor shaft of the vertical axis wind supply unit is increased and power generated by the generator set is raised.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment of a vertical axis wind turbine system according to the present invention;

FIG. 2 is a schematic drawing showing a front view of an embodiment of a vertical axis wind turbine system according to the present invention;

FIG. 3 is a schematic drawing showing a front view of a cross section of a blade of an embodiment according to the present invention;

FIG. 4 is a partial perspective view of an upwind surface of a blade of an embodiment according to the present invention;

FIG. 5 is a partial perspective view of a downwind surface of a blade of an embodiment according to the present invention;

FIG. 6 is a schematic drawing showing a front view of an embodiment of a vertical axis wind turbine system fixed by fixing ropes according to the present invention;

FIG. 7 is a schematic drawing showing a front view of an embodiment of a vertical axis wind turbine system having two sets of one-way force-taken vertical axis wind supply units and the upper connection plate connected in series according to the present invention.

### DETAILED DESCRIPTION OF THE PREFERRED EMBODIMENT

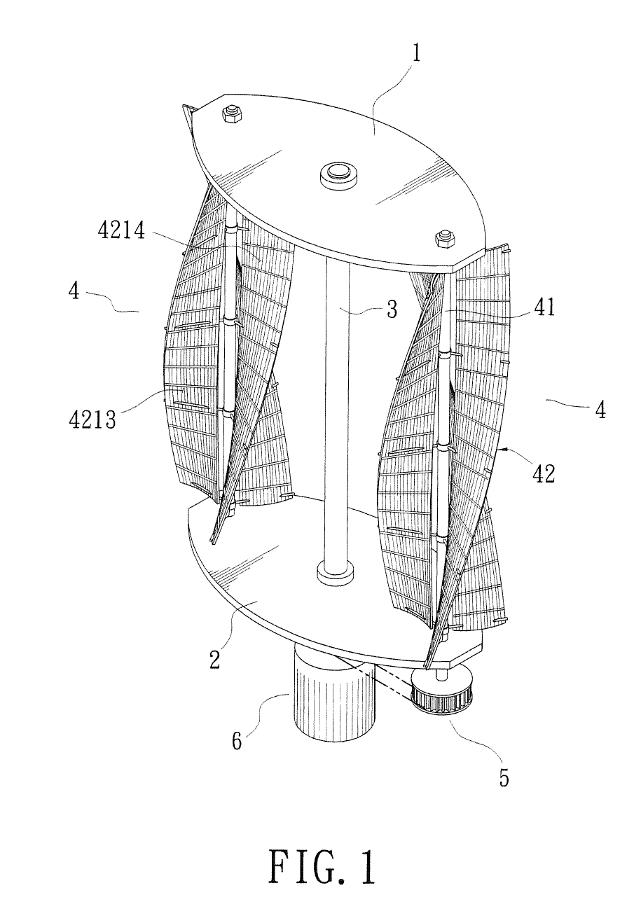

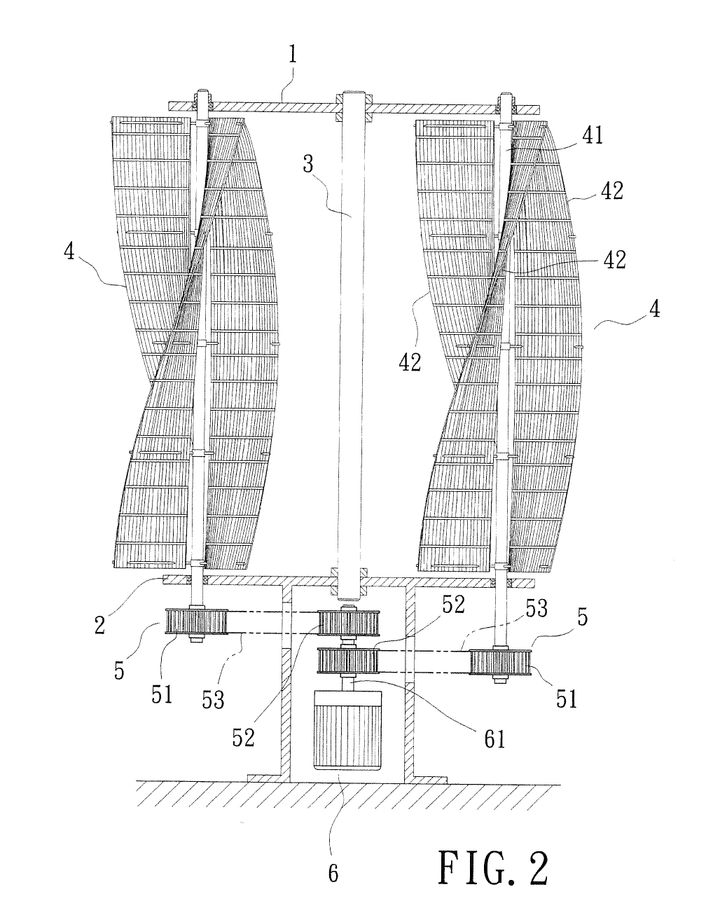

Refer to FIG. 1 and FIG. 2, a vertical axis wind turbine system of the present invention mainly includes an upper connection plate 1, a lower connection plate 2, a support rod 3, two vertical axis wind supply units 4, two transmission sets 5 and a generator set 6.

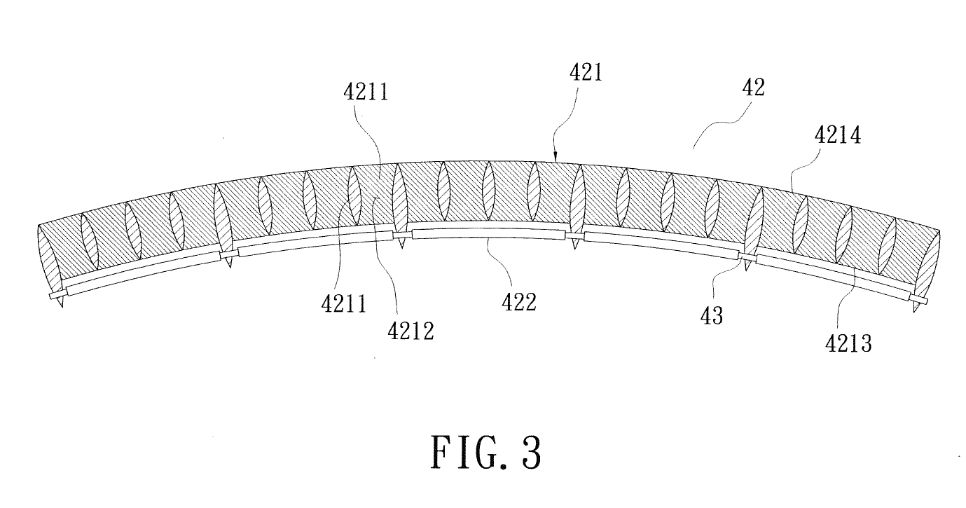

The support rod 3 is assembled between centers of the upper connection plate 1 and the lower connection plate 2. The two vertical axis wind supply units 4 are respectively arranged between two sides of the upper connection plate 1 and the lower connection plate 2. The vertical axis wind supply unit 4 receives forces only in one direction and includes three blades 42 arranged equally around a rotor shaft 41. Also refer to FIG. 3, each blade 42 includes a blade body 421 and at least one valve 422. The blade body 421 is a curved and helical plate formed by a plurality of horizontal and perpendicular barriers 4211 whose cross section is wing shaped. A plurality of insertion holes 4212 is formed among the crossed barriers 4211. The blade body 421 further has an upwind surface 4213 and a downwind surface 4214. A plurality of valves 422 is fixed on the upwind surface 4213. The valve 422 is connected to the blade body 421 only by the upper side thereof. Each valve 422 is corresponding to at least one insertion hole 4212. Each of the two rotors 41 is connected to the generator set 6 by the transmission set 5 respectively. The rotor shaft 41 can be made from low-cost materials such as plastics. Once the rotor shaft 41 is made from non-metal material and is not connected to the generator set 6 directly, the cost is down and the over-voltage caused by magnetic induction or a lightning stroke can be avoided.

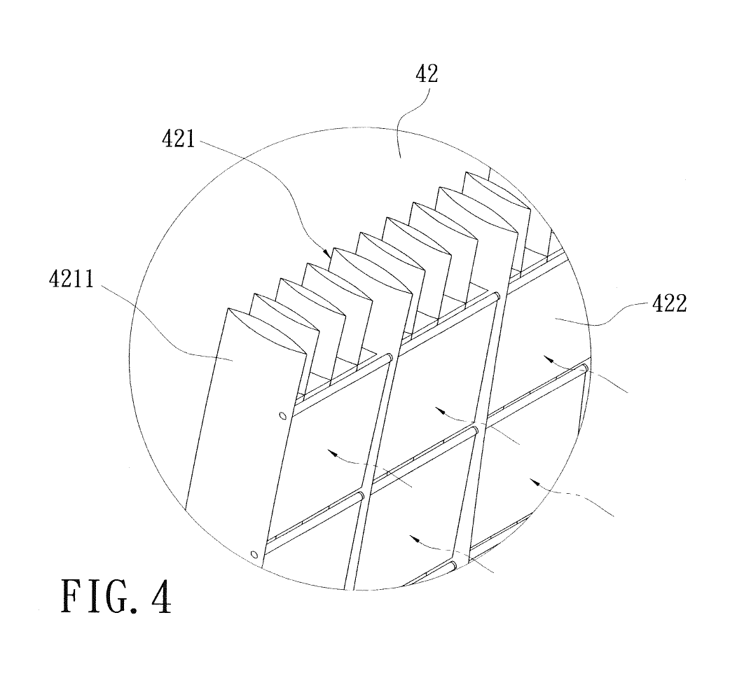

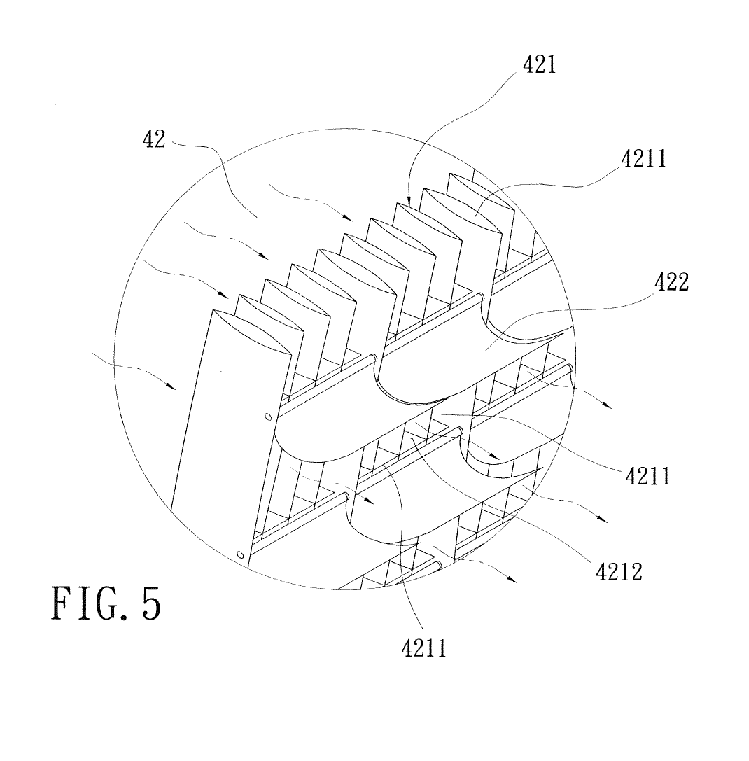

Due to the valves 422 connected to the upwind surface 4213 of the blade body 421 only by the upper side thereof and each valve 422 corresponding to at least one insertion hole 4212, the valves 422 are attached closely to each insertion hole 4212 under the action of the wind power when a force of wind is applied to the upwind surface 4213 of the blade body 421, as shown in FIG. 4 and FIG. 5. Thus the wind power is applied to the upwind surface 4213 completely. When a force of wind is applied to the downwind surface 4214 of the blade body 421, the wind passes through the insertion holes 4212 of the blade body 421 to blow the valves 422 open so that the valves 422 are separated from the insertion holes 4212. Thus the resistance over the downwind surface 4214 of the blade body 421 caused by the wind is reduced. Therefore the working efficiency of the vertical axis wind turbine system 4 is improved.

When the two one-way force-taken vertical axis wind supply units 4 rotate around the corresponding rotor shaft 41, the transmission sets 5 are also driven by the rotor shafts 41. Then the transmission sets 5 further drive the generator set 6 to generate power. Thus the kinetic energy of the air is converted into mechanical energy for producing electricity. Due to the vertical axis wind supply units 4 that receive force only in a single direction, the power generation efficiency of the vertical axis wind turbine system of the present invention is increased. Moreover, the present invention uses two sets of one-way force-taken vertical axis wind supply units 4 to drive the generator set 6 so that the power generation efficiency is increased significantly in the same land area.

Refer to FIG. 3, the valves 422 are fixed on the upwind surface 4213 of the blade body 421 by cables 43. The cable 43 passes through the upper side of each valve 422 and then two ends of the cable 43 are fixed on the blade body 421. Thereby the valves 422 are fastened tightly on the blade body 421.

Back to FIG. 2, the transmission set 5 consists of a drive wheel 51 fixed on the rotor shaft 41 of the vertical axis wind supply unit 4, a driven wheel 52 fixed on an operating shaft 61 of the generator set 6, and a drive belt 53 enclosed around the drive wheel 51 and the driven wheel 52. The rotor shaft 41 drives the drive wheel 51 and then the driven wheel 52 is further driven by the drive belt 53. Thus the operating shaft 61 connected with the driven wheel 52 is further driven and rotated.

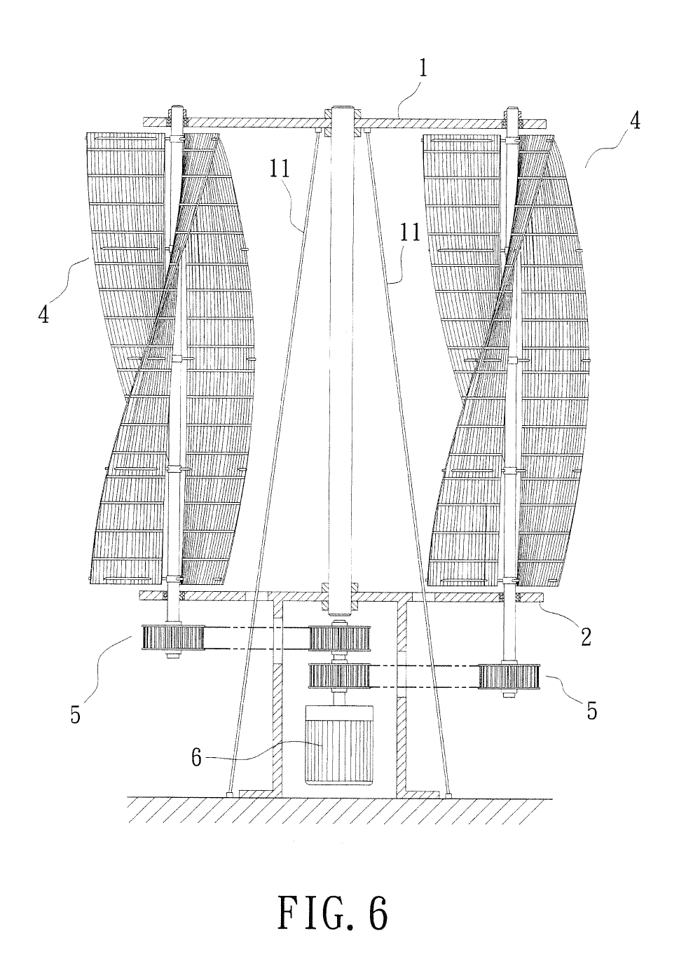

Furthermore, one end of each of a plurality of fixing ropes 11 is fixed on the upper connection plate 1, as shown in FIG. 6. The other end of the fixing rope 11 is fixed on buildings or on the ground so as to install the vertical axis wind turbine system of the present invention on the buildings or on the ground.

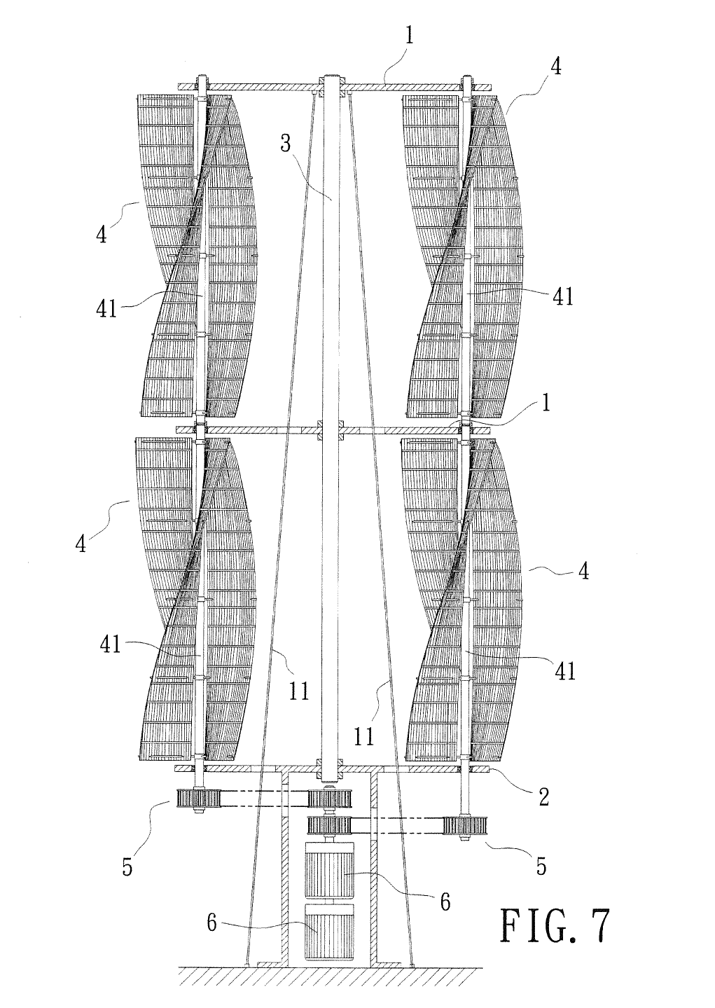

In addition, the two one-way force-taken vertical axis wind supply units 4 and the upper connection plate 1 have been modularized. Along the rotor shaft 41 of the one-way force-taken vertical axis wind supply unit 4, a plurality sets of modularized one-way force-taken vertical axis wind supply units 4 can be connected on top of the upper connection plate 1, as shown in FIG. 7. By the design of series connection of the plurality sets of the one-way force-taken vertical axis wind supply units 4, rotary power of the rotor shaft 41 of the vertical axis wind supply unit 4 is increased and is transmitted to the generator set 6 through the transmission set 5 so as to increase power generated by the generator set 6.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A vertical axis wind turbine system comprising: an upper connection plate, a lower connection plate, a support rod, at least two vertical axis wind supply units, two transmission sets and a generator set; wherein the support rod is arranged between a center of the upper connection plate and a center of the lower connection plate; the vertical axis wind supply units that receive force in one direction are respectively arranged between two sides of the upper connection plate and the lower connection plate; the vertical axis wind supply unit includes three blades disposed equally around a rotor shaft and each blade includes a blade body and a plurality of valves; the blade body is a curved and helical plate having a plurality of crossed barriers and a plurality of insertion holes among the crossed barriers; cross section of each barrier is wing-shaped; each valve is fixed on an upwind surface of the blade body by an upper side thereof connected to the blade body and is corresponding to at least one insertion hole; each of the rotor shaft is connected to the generator set by the transmission set.

2. The device as claimed in claim 1, wherein a cable passes the upper side of the valve and then two ends of the cable are fixed on the blade body.

3. The device as claimed in claim 2, wherein the upper connection plate is connected with one end of each of a plurality of fixing ropes while the other end of each fixing rope is fixed on buildings or on the ground.

4. The device as claimed in claim 3, wherein along the rotor shaft of the vertical axis wind supply unit, a plurality sets of the two vertical axis wind supply units is connected in series on top of the upper connection plate.

5. The device as claimed in claim 4, wherein the transmission set includes a drive wheel fixed on the rotor shaft of the vertical axis wind supply unit, a driven wheel fixed on an operating shaft of the generator set, and a drive belt enclosed around the drive wheel and the driven wheel.

6. The device as claimed in claim 1, wherein the upper connection plate is connected with one end of each of a plurality of fixing ropes while the other end of each fixing rope is fixed on buildings or on the ground.

7. The device as claimed in claim 1, wherein along the rotor shaft of the vertical axis wind supply unit, a plurality sets of the two vertical axis wind supply units is connected in series on top of the upper connection plate.

8. The device as claimed in claim 1, wherein the transmission set includes a drive wheel fixed on the rotor shaft of the vertical axis wind supply unit, a driven wheel fixed on an operating shaft of the generator set, and a drive belt enclosed around the drive wheel and the driven wheel.

9. The device as claimed in claim 1, wherein the rotor shaft is made from non-metal material.

10. The device as claimed in claim 9, wherein the non-metal material of the rotor shaft is plastic.
